(19) United States
(12) Patent Application Publication
(10) Pub. No.: US 2022/0281568 A1
(43) Pub. Date: Sep. 8, 2022

(54) MARINE POWER STRUCTURE AND COASTAL NUCLEAR POWER STATION THEREFOR

(71) Applicant: Energie propre Prodigy Ltee / Prodigy Clean Energy Ltd., Montreal (CA)

(72) Inventors: Mathias TROJER, Brookline, MA (US); Marcel DEVOS, Oxford Station (CA)

(21) Appl. No.: 17/687,194

(22) Filed: Mar. 4, 2022

Related U.S. Application Data
(60) Provisional application No. 63/156,677, filed on Mar. 4, 2021.

(51) Int. Cl. B63B 35/44; G21C 1/32; B63B 39/06; B63B 39/03

(52) U.S. Cl. CPC B63B 35/44; G21C 1/32; B63B 39/06; B63B 39/03; B63B 2035/4446

(57) ABSTRACT

A marine power structure includes a building structure adapted to float on a body of water having a water surface. The mobile structure is transportable to a deployment location. The marine power structure also includes a nuclear enclosure disposed within in the building structure with a nuclear reactor disposed therein. A primary coolant system is connected to the nuclear reactor permitting heat generated by the nuclear reactor to be transferred thereto. At least one stabilizer is provided. The stabilizer is adapted to engage the building structure. The at least one stabilizer assists to maintain the stability of the building structure at the deployment location.

### CROSS-REFERENCE TO RELATED APPLICATION(S)

This United States Non-Provisional patent application relies upon and claims priority to U.S. Provisional Patent Application Ser. No. 63/156,677, filed on Mar. 4, 2021, the entire content of which is incorporated herein by reference.

### FIELD OF THE INVENTION

The present invention is directed to a marine power structure permitting a nuclear reactor to be transported and installed at a predetermined deployment location. The present invention also concerns a coastal nuclear power station that includes a harbor adapted to receive the mobile marine power structure. The nuclear reactor may be of a type commonly referred to as a Small Modular Reactor (SMR).

### BACKGROUND OF THE INVENTION

The global need for energy sources that are sustainable, low-cost, produce low carbon emissions, and have high capacity factor is growing rapidly. Various novel nuclear power plant designs, including some that incorporate small modular reactors (SMRs), can meet this need while overcoming the drawbacks of earlier nuclear plants.

It is desirable that novel plant designs minimize development footprint (e.g., near coastal population centers). Moreover, to be secure and sustainable, novel designs must be robust against potential impacts of climate change, including sea level rise and dwindling supplies of freshwater for cooling. They should be robust against mechanical failures, malicious attack, human error, and natural disasters, including seismic events and tsunamis.

Plant designs also should avoid the high costs and decadal construction times that have persistently plagued large, one-off nuclear plants: site-specific design, approval, and construction processes entail high construction costs and long project durations that make conventional nuclear power projects expensive to finance and insure.

Coastal deployments of prefabricated nuclear power plants can address the foregoing needs. Such deployments can minimize development footprint, have access to inexhaustible coolant water (the sea), and benefit from marine delivery of large components that must otherwise be built on-site.

Various nuclear-plant proposals of the prior art realize only some of these advantages.

A need thus exists for methods and systems that standardize design and construction of nuclear plants for coastal deployments; exploit the potential of marine transport for rapid, flexible delivery of large systems; minimize site-specific bespoke engineering costs; and realize other advantages of coastal deployments.

### SUMMARY OF THE INVENTION

The present invention provides methods, systems, components, and the like that enable centralized manufacturing, transporting, deploying, redeploying, fueling, and commissioning of a marine nuclear power plant structure, herein termed a Marine Power Structure (MPS).

In various embodiments the MPS is a floatable structure comprising a number of small modular reactors (SMRs) stationed within a dedicated internal volume, the nuclear enclosure. All elements of an SMR-based nuclear island, including those designed specifically for terrestrial application, are preferably contained within the nuclear enclosure of the MPS: in this case a nuclear island designed for terrestrial locations can be translated as a whole, with no modifications or few modifications, into the nuclear enclosure of the MPS.

The MPS also, in various embodiments, contains some or all additional elements of a nuclear power station (e.g., turbines, generators, control room, balance of plant systems, auxiliary systems, fuel handling systems, administration buildings and living quarters etc.).

The MPS is agnostic toward the specific design of the nuclear enclosure and of the SMRs within, that is, can accommodate any of a number of SMR or reactor designs and nuclear island layouts, present and future. Although the term “SMR” is employed herein, there is no restriction to any particular reactor design or type, fission or fusion, or other variations found in present or future nuclear heat generators.

Preferably, standardized heat transport, electrical, and control interfaces connect the nuclear enclosure to the other systems of the MPS. The nuclear enclosure is thus a “black box” within the MPS that produces heated fluids (e.g., steam, carbon dioxide, molten salt, etc.), which are converted to electrical power by standard systems and which may also provide heat for direct applications (heating, industrial process heat, etc.). The floatable MPS is preferably fabricated in a shipyard and transported overwater, sans reactors and nuclear fuel, to a dedicated slip comprised by a coastal facility.

The slip provides for protection of the MPS, and particularly of its nuclear enclosure, against aircraft impacts, seismic events, tsunamis, and other challenges.

The balance of the coastal facility typically includes one or more switchyards, administrative buildings, connections to a standard grid or microgrid, energy storage devices and other components pertain to energy transformation, storage, and distribution. In some embodiments, power conversion occurs in the balance of the coastal facility rather than in the MPS.

Reactors and fuel are preferably installed in the MPS after the MPS is installed at the coastal facility. The MPS comprises provisions for exchanging reactors and fresh and spent nuclear fuel between one or more land- or sea-based delivery systems and the interior of the nuclear enclosure.

Various embodiments of the invention realize a number of advantages over the prior art for creating nuclear power stations. These include shipyard fabrication of the MPS and its nuclear envelope, which enables faster construction and lower capital expenditure than one-off, on-site, terrestrial construction; turnkey delivery of one or more MPSs to a coastal facility; flexible overwater transport from the MPS site of manufacture to the coastal facility; redeployability of the MPS (e.g., to another coastal facility), with attendant flexibility of business construct (e.g., short- or long-term leasing); portability of MPS at end-of-lifetime to a maritime scrapyard for cost-effective decommissioning; ability to locate the MPS anywhere in the world accessible by water, regardless of availability of terrestrial infrastructure (e.g., roads); seismic isolation of the MPS; tsunami resistance; immunity to flooding; easy adaptation to sea-level rise; and access to an effectively unlimited supply of cooling water, in contrast to conventional terrestrial nuclear plants that may be forced to cease operation when drought reduces cooling water supply.

In one aspect, the present invention provides a marine power structure. The marine power structure includes a building structure adapted to float on a body of water having a water surface. The building structure is transportable to a deployment location. A nuclear enclosure is disposed within in the building structure. A nuclear reactor is disposed within the nuclear enclosure. The nuclear reactor generates heat. A primary coolant system is connected to the nuclear reactor. The heat is transferred to a primary coolant within the primary cooling system and the primary coolant, after being heated, generates a heated fluid. At least one stabilizer is adapted to engage the building structure. The at least one stabilizer assists to maintain the stability of the building structure at the deployment location.

In one contemplated embodiment the marine power structure also includes a ballast system. The ballast system is adapted to alter a buoyancy of the building structure, permitting at least a portion of the nuclear enclosure to be lowered below the water surface.

In another contemplated embodiment, the building structure excludes a propulsion system.

The present invention encompasses a marine power structure where the nuclear reactor comprises a small modular reactor having a power output of between about 1 megawatts (MWe) to about 100 megawatts (MWe).

Still further, in the marine power structure of the present invention, the building structure may have an outer hull and an inner hull. If so, the inner hull is disposed within the outer hull. A space is defined between the inner hull and the outer hull. The space is contemplated to contain at least one of Y-shape stringers, water, liquid, granular material, concrete, and radiation shielding.

In another contemplated embodiment of the present invention, the nuclear reactor encompasses a plurality of nuclear reactors.

Still further, the marine power structure also may include a fuel handling area within the nuclear enclosure, permitting transfer of nuclear fuel to and from the nuclear reactor.

Next, it is contemplated that the marine power structure may have a passive cooling system connected between the nuclear reactor and the body of water to passively conduct heat from the nuclear reactor to the body of water.

If a passive cooling system is provided, it is contemplated that the nuclear reactor will be disposed within a container and the passive cooling system will have a secondary cooling loop in thermal contact with the container.

The secondary cooling loop may include a manifold and a plurality of vertically-oriented loops connected to the manifold. The plurality of vertically-oriented loops may be disposed exteriorly to the building structure, within the body of water.

The present invention also is contemplated to provide a coastal nuclear power station. The coastal nuclear power station includes a harbor that encompasses a landmass abutting a body of water having a water surface, a slip extending into the landmass, where the slip has at least one breakwater defining a transition from the landmass to the body of water, and a marine power structure disposed within the slip. The marine power structure includes a building structure adapted to float on a body of water having a water surface, where the mobile structure is transportable to a deployment location, a nuclear enclosure disposed within in the building structure, a nuclear reactor disposed within the nuclear enclosure, where the nuclear reactor generates heat, a primary coolant system connected to the nuclear reactor, where the heat is transferred to a primary coolant within the primary cooling system and where the primary coolant, after being heated, generates a heated fluid. The coastal nuclear power station also includes at least one stabilizer adapted to engage the building structure, where the at least one stabilizer assists to maintain the stability of the building structure at the deployment location. The coastal nuclear power station also includes a foundation disposed within the slip, beneath the water surface, at the deployment location. The foundation is adapted to receive the building structure.

In one contemplated embodiment of the present invention, the coastal nuclear power station includes a ballast system. The ballast system enables the building structure to float on the water surface and also to sink into the body of water and rest atop the foundation.

The coastal nuclear power station also may be configured so that, when the building structure rests atop the foundation, at least a portion of the nuclear enclosure is below the water surface.

Still further, the coastal nuclear power station may include a plurality of seismic isolators disposed on the foundation, between the foundation and the building structure.

The present invention also encompasses a method for managing a marine power structure. The method includes constructing a slip into a landmass, where the slip comprises at least one breakwater defining a transition from the landmass to a body of water with a water surface, laying a foundation in the slip beneath the water surface, delivering a marine power structure to the slip, and reducing the buoyancy of the building structure until the building structure rests on the foundation and engages at least one stabilizer adapted to engage the building structure to maintain the stability of the building structure in the slip. The marine power structure includes a building structure adapted to float on the water surface, a nuclear enclosure disposed within in the building structure, a nuclear reactor disposed within the nuclear enclosure, where the nuclear reactor generates heat, and a primary coolant system connected to the nuclear reactor, where the heat is transferred to a primary coolant within the primary cooling system and wherein the primary coolant, after being heated, generates a heated fluid.

These and other distinguishing aspects of embodiments of the invention, along with various advantages of embodiments, will be clarified hereinbelow with reference to the Figures.

### BRIEF DESCRIPTION OF THE DRAWING(S)

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1A depicts a marine power structure (MPS) containing a nuclear island.

FIG. 1B is a transverse cross-sectional view of the MPS of FIG. 1A.

FIG. 1C is a different transverse cross-sectional view of the MPS of FIG. 1A.

FIG. 2 depicts an MPS installed in a coastal power station.

FIG. 3A and FIG. 3B depict an MPS docked in a slip at two different ballasting levels.

FIG. 4 depicts the layout of a nuclear island comprised by an MPS.

FIG. 5A and FIG. 5B depicts an SMR in a dedicated coolant containment.

FIG. 6A depicts SMRs, each equipped with a dedicated coolant containment, in a nuclear island in a first state of operation.

FIG. 6B depicts SMRs, each equipped with a dedicated coolant containment, in a nuclear island in a second state of operation.

FIG. 7A depicts an SMR with convective cooling loops.

FIG. 7B depicts an SMR with convective cooling loops and two manifolds.

FIG. 7C depicts an SMR with convective cooling loops and a single manifold.

FIG. 7D depicts the SMR cooling arrangement of FIG. 7C in a top-down view.

### DETAILED DESCRIPTION OF EMBODIMENT(S) OF THE INVENTION

The present invention will now be described in connection with one or more embodiments. The discussion of the present invention in connection with enumerated embodiments is not intended to be limiting of the present invention. To the contrary, the discussion of specific embodiments is intended to highlight the broad scope of the present invention. Variations and equivalents of any of the described embodiments are intended to be encompassed by the discussion that follows and by the scope of the claims appended hereto.

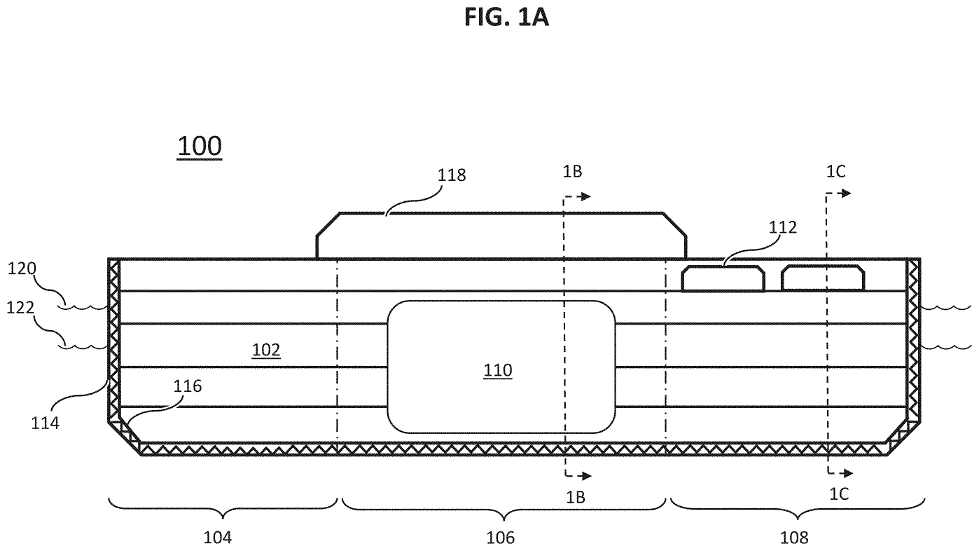

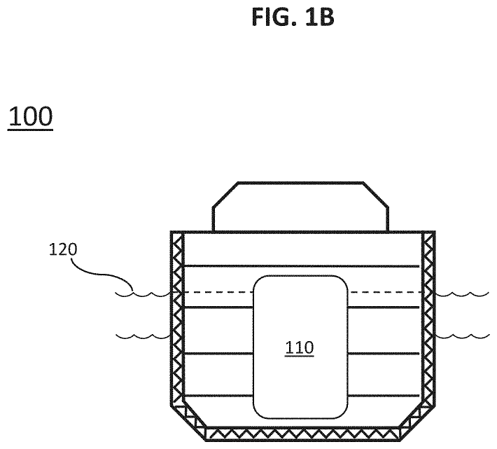

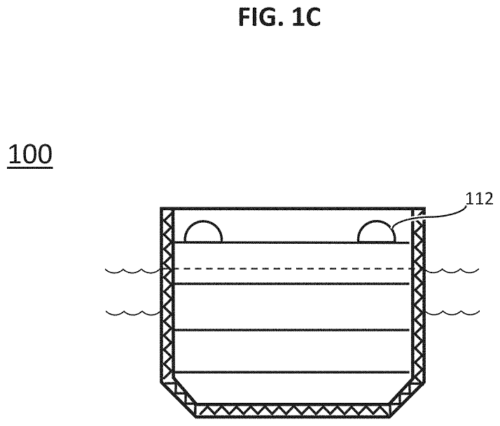

FIG. 1A schematically depicts a marine power structure (MPS) 100 in longitudinal cross-section according to an illustrative embodiment of the invention. FIG. 1B depicts the MPS 100 of FIG. 1A in transverse cross-section at the broken line 1B-1B, and FIG. 1C depicts the MPS 100 of FIG. 1A at the broken line 1C-1C.

The MPS 100 comprises a building structure, the details of various embodiments of which are provided hereinbelow. In one embodiment, the building structure is configured as a hull adapted to float on the surface of a body of water. In this embodiment, the building structure is configured as a barge or similar seaworthy vessel lacking a propulsion system. Alternatively, the building structure may include a propulsion system without departing from the scope of the present invention.

Referring now to FIG. 1A, The MPS 100, which is preferably built at a shipyard, is a building structure that comprises a number of decks (e.g., deck 102) and is divided into three functional sections, that is, an annex section 104, a reactor section 106, and a balance-of-plant section 108, whose boundaries are indicated by vertical dash-dot lines in FIG. 1A.

The reactor section 106 comprises a nuclear island or enclosure 110 which contains at least one or, preferably, a number of small modular reactors (SMRs, not depicted in FIG. 1A), preferably in a standard reactor-building configuration that has already been approved by regulators for terrestrial deployment. In an example, and as shall be clarified hereinbelow with reference to the illustrative embodiments of later Figures, the illustrative nuclear enclosure 110 contains a dozen NuScale Power Module SMRs (“NuScale Power Module” is understood to be a trademark of NuScale Power, having a business address at 6650 SW Redwood Lane, Suite 210, Portland, Oreg. 97224). Each NuScale SMR generates a quantity of steam capable of supporting an electrical power output of approximately 50 to 70 megawatts (MWe).

For purposes of the present invention, the nuclear reactor, including any SMRs, is contemplated to generate 1 MWe to 100 MWe. In one embodiment, the nuclear reactor may generate 10 MWe to 90 MWe. In another contemplated embodiment, the nuclear reactor may generate 20 MWe to 80 MWe. In other embodiments, the nuclear reactor may generate 30 MWe to 70 MWe, 40 MWe to 60 MWe, or about 50 MWe. As noted, the nuclear reactor is contemplated to generate 50 MWe to 70 MWe in a typical, contemplated configuration. For reference, “MWe” refers to megawatts of electrical power.

In general, SMRs offer a number of potential advantages over the relatively large (gigawatt-scale) nuclear reactors conventionally employed for commercial power generation; these advantages include but are not limited to lower accident risk due to passive internal coolant circulation, standardized mass manufacture, adjustment of total generating capacity of a multi-SMR facility by addition or removal of SMRs, swap-out and refueling capability for individual SMRs at a multi-SMR facility without shutdown of the whole facility, and ability to be delivered by truck or barge as enabled by SMR form factor (e.g., <5 meters wide by 30 meters high).

The nuclear enclosure 110 is analogous to the nuclear island of a terrestrial nuclear generating facility, enclosing all nuclear systems aboard the MPS 100. The MPS 100 as such, however, is reactor-design neutral within the dimensional constraints of its nuclear enclosure 110: that is, any type or number of reactors that can fit inside the enclosure 110 may be installed therein.

The nuclear enclosure 110 forms a sealed “black box” accessible only to a qualified nuclear operator. It enables the bundling of multiple reactors into a single containment envelope having a limited number of standardized physical (e.g., heat transport and electrical) interfaces with the non-nuclear systems of the MPS 100, which in this example include but are not limited to power conversion, heat removal, and control systems. Layers of shielding and cooling within the nuclear enclosure 110 provide protections for personnel and the environment additional to those of the individual SMR, and the MPS 100 itself may comprise still further provisions for shielding and cooling that are external to the nuclear enclosure 110.

The balance-of-system portion 108 of the MPS 100 comprises standard turbine-generators (e.g., turbine-generator 112) which exchange heat via a heat transport fluid with the nuclear enclosure 110. Specifically, as should be apparent to those skilled in the art, the nuclear reactor within the nuclear enclosure 110 contains a nuclear core containing fissile material. The nuclear core generates heat, which is transferred to a primary coolant, within a primary cooling system, surrounding the core. The primary coolant, in turn, is circulated to pass through at least one heat exchanger to transfer the heat from the primary coolant to a secondary coolant in a secondary cooling system. The secondary coolant may be a fluid, such as water. When the secondary coolant is water, the water is heated to produce steam. The steam is then provided to a power generator, such as the turbine generator 112. Electricity is generated by the turbine generator 112.

It is noted that the nuclear enclosure 110 generates steam or connects to other systems (e.g., the secondary cooling system) that generate steam. That steam may be used by ancillary systems connected to the MPS 100. Additionally, the steam may be used by one or more turbine-generators 112 to generate electricity.

Electricity generated by the turbine-generators 112 of the MPS 100 is delivered to a coastal facility at which the MPS 100 is docked. Transformers, bus bar connectors, and other gear for interfacing with a grid are preferably comprised by the coastal facility but may additionally or alternatively be comprised by the MPS 100. The MPS 100 may also comprise diesel generators, fuel cells, or other means of generating its own electrical power, and may be connected, directly or through an intermediate facility, with a grid, coastal facility, or other facility that supplies power to and/or receives power from the MPS 100. For simplicity, electrical and steam connections, independent generation systems, and various other connections and components of the MPS 100 are omitted from FIG. 1A. Preferably, all non-nuclear systems are installed in the MPS 100 in the shipyard that manufactures it, or at a secondary shipyard, and are delivered to the coastal facility with the rest of the MPS.

The illustrative MPS 100 may be a vessel, such as a barge, that comprises an inner hull 114 and outer hull 116 in order to provide a higher grade of protection to its contents, particularly the nuclear enclosure, than a single-hulled vessel. The space between the inner hull 114 and outer hull 116 may be reinforced with Y-shape stringers, a technique that will be familiar to persons trained in the art of marine engineering, in order to provide enhanced resistance to challenges such as penetration by a vessel, aircraft, or stationary object. Other forms of hull reinforcement known to the shipbuilding art may also be employed. In FIG. 1A, FIG. 1B, and FIG. 1C, hull reinforcement is indicated by a zigzag line. The space between the two hulls may also be filled, in various states of operation of the MPS 100, with water or some other liquid, granular material, or concrete, in order to ballast the vessel and to provide additional shielding against ingress by objects and egress by radiation. A superstructure 118 is reinforced to protect the nuclear enclosure 110 from aircraft impacts and may also comprise observation decks and the like.

As noted, the MPS 100 is preferably not equipped with a propulsion system, but is moved at sea by tugboats or similar vessels, or is lifted and moved by a marine carrier such as the Boskalis semi-submersible heavy lift vessel Vanguard, which is capable of lifting 117,000 tons, or by an equivalent carrier. The MPS 100 is preferably dimensioned to be accommodated by such a commercial carrier.

The MPS 100 is designed to operate at two or more distinct load lines or depths, e.g., an upper line 120 and a lower line 122. During transport, the MPS 100 floats higher and its waterline is at the lower level 122. When deployed at a coastal facility, the MPS 100 is ballasted to float lower and its waterline is at the higher level 120. When the MPS 100 is ballasted so that its waterline is at the lower level 122, it has a shallower draft and is thus easier to tow and to maneuver (e.g., in shallow coastal waters). It is contemplated, for example, that the MPS 100 may include a ballast system with one or more ballast tanks (not shown) that may be filled and/or emptied in a conventional manner, as should be apparent to those skilled in the art. Still further, the MPS 100 might include any other type of ballast system so that the buoyancy (e.g., displacement or draft) of the MPS 100 may be adjusted.

Preferably, no nuclear material is aboard the MPS 100 during transport to its deployment site. Instead, SMRs and nuclear fuel are delivered to the deployment site and installed within the nuclear enclosure 110 after the MPS 100 has been installed at its deployment site. MPS 100 comprises handling mechanisms that enable the installation and removal of nuclear fuel and of whole SMRs throughout the service lifetime of the MPS 100. Refueling of SMRs preferably takes place within the nuclear enclosure 110, which acts as a “black box” to which only a qualified nuclear operator has access and within which all nuclear activities occur independently of the rest of the MPS 100.

FIG. 1B depicts a schematic cross-section of the MPS 100 at the broken line 1B-1B of FIG. 1A, clarifying the relation of the nuclear enclosure 110 to the MPS 100 as a whole. When the MPS 100 is ballasted so that its waterline is at the higher level 120, the nuclear envelope 110 is substantially or entirely below the upper waterline 120, as indicated by a horizontal broken line in FIG. 1B. Moreover, as will be clarified with reference to later Figures, ballasting down the MPS 100 enables the bottom of the MPS 100 to rest upon a prepared surface or supports, e.g., seismic isolators. The prepared surface may be any type of foundation, as should be apparent to those skilled in the art. Contemplated foundations include, but are not limited to, concrete slab(s), gravel, sand, clay, and combinations thereof.

FIG. 1C depicts a schematic cross-section of the MPS 100 at the broken line 1C-1C of FIG. 1A, clarifying the relation of the turbine-generators (e.g., turbine-generator 112) to the MPS 100 as a whole. The turbine-generators 112 are located and oriented so that if a piece of rotating heavy machinery explodes, centrifugal force will not direct fragments toward the nuclear enclosure 110.

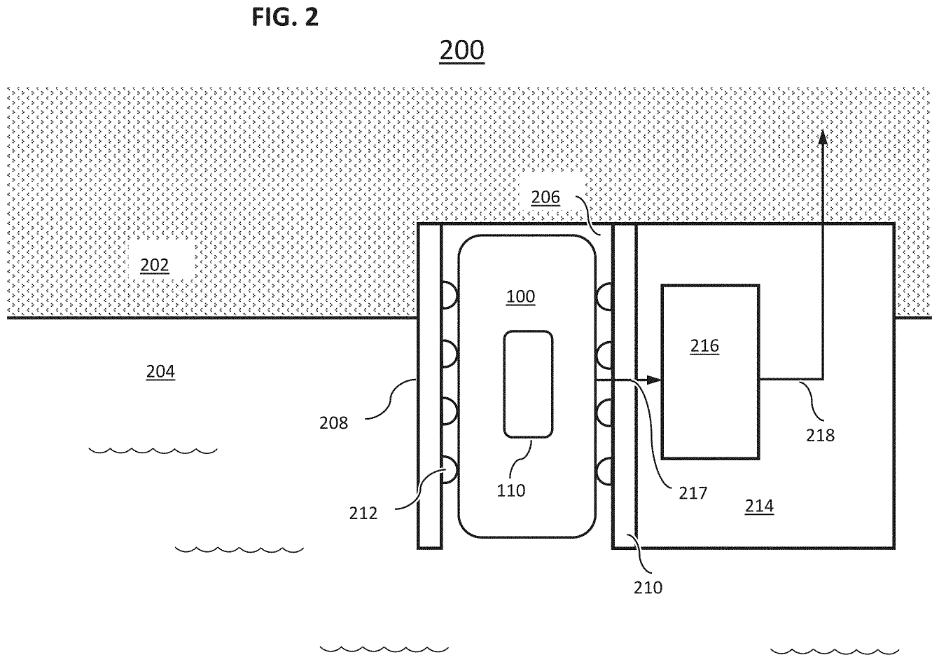

FIG. 2 schematically depicts a coastal nuclear power station 200 in top-down view according to an illustrative embodiment of the invention. The coastal station 200 is located along the shore of a landmass 202 abutting a body of water 204 and comprises a slip or artificial harbor 206 cut into the shore and bounded by breakwaters 208, 210. An MPS 100 comprising a nuclear enclosure 110 is docked in the slip 206. Stabilizing shock absorbers (e.g., bumpers 212) along the breakwaters 208, 210 are in contact with, or nearly in contact with, the sides of the MPS 100. The station 200 also comprises an ancillary facility or campus 214 which contains a switchyard 216 and potentially other facilities (not depicted), such as energy storage devices, backup generators, offices, housing, manufacturing facilities, fuel bunkers, and the like.

Preferably all major components of the power station 200 other than the MPS 100, e.g., harbors, port facilities, vessel bunkering facilities, and energy generation facilities are constructed before installation of the MPS 100. The MPS 100 could be deployed to complement existing infrastructure as-is or the existing infrastructure could be repurposed.

Cabling 217 conveys power generated aboard the MPS 100 to the switchyard 216, the switchyard 216 conveys power to a transmission line 218 that feeds a grid, extensive or micro. Additional cabling (not depicted) delivers power from the grid and/or from energy storage devices comprised by the campus 214 to the MPS 100. The campus or ancillary facility 214 may be connected to additional generators, such as wind turbines.

Moreover, in various embodiments the MPS 100 does not contain turbine-generators but instead delivers steam to turbine-generators comprised by the ancillary facility 214, which comprises all power conversion systems necessary to transform thermal energy into electricity for grid distribution. In various embodiments the MPS 100 delivers both electricity and steam to the ancillary facility 214. In embodiments where the MPS 100 delivers steam to the ancillary facility 214, the facility 214 may comprise thermal energy storage facilities and/or industrial facilities that use the steam for process heat.

The MPS 100 is preferably manufactured in a shipyard under strict quality and schedule controls meeting requirements for nuclear-qualified manufacture, and the nuclear enclosure 110 meets regulatory requirements for a structure housing SMRs, nuclear fuel, and other nuclear systems. Therefore, structures comprised by the ancillary facility 214 of the station 200 will typically not be subject to safety and quality regulations pertaining to nuclear building and manufacture.

Coastal power stations according to various embodiments of the invention may contain more than one MPS 100. Also, according to various embodiments, the landmass 202 may be an artificial island. Moreover, the layout of the station 200 of FIG. 2 is illustrative only: no restriction on deployment geometry, or the extent or nature of ancillary facilities 214, is intended.

The station 200 can deployed at a specific coastal location or on an artificial island either as the sole source of energy generation or in combination with wind, solar, tidal, wave, or other forms of energy generation. Power from the station 200 can be delivered to a grid or employed locally or remotely for various energy-consuming activities such as, for example, metals processing, cement production, or production of carbon-neutral fuels such as hydrogen or ammonia synthesized using atmospheric carbon. Thus, in an example, the site of the station 200, or a nearby location, comprises bunkering facilities for carbon-neutral synthetic fuels to support a low-carbon energy economy. Deployment of the station 200 on an artificial island would be advantageous in mitigating the siting constraints often associated with development of terrestrial nuclear power plants.

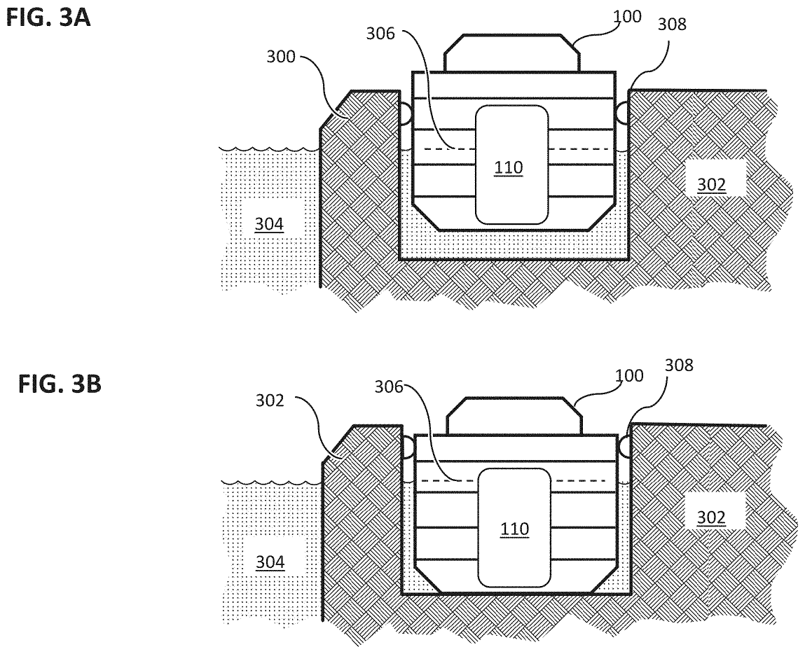

FIG. 3A and FIG. 3B schematically depict in transverse cross-section two states of ballasting of an MPS 100 comprising a nuclear envelope 110 and docked within a slip comprised by a coastal power station similar to station 200 of FIG. 2, according to an illustrative embodiment of the invention. In a first state of ballasting (upper image), the MPS 100 rides high enough to be easily maneuvered into the slip, which is bounded by breakwaters or protective walls 300, 302 which define the transition from the landmass to the body of water. The interior of the slip communicates at one end (not depicted) with an ocean or other large body of water 304 so that the water level 306 in the slip is the same as that in the body of water 304.

Of note, during this first state of ballasting at least a portion, possibly a significant portion, of the nuclear envelope 110 is above the water level 306. In a second state of ballasting (lower image), the MPS 100 is grounded on the floor of the slip. In this state, the MPS 100 may rest upon seismic isolators (not depicted) or a prepared seabed or other material that mitigates the transmission of seismic shocks from the earth to the hull of the MPS 100.

Also, in the second state of ballasting, the nuclear envelope 110 is entirely (100%) or almost entirely (greater than about 90%) below the waterline 306. The second state of ballasting is the preferred long-term, operational position of the MPS 100. In this state, the MPS 100 is constrained from excessive pitch, roll, yaw, and transverse displacement in response to tsunami, earthquake, or other forces. This stabilizes the MPS 100 as a whole and thus the nuclear envelope 110 within it. Moreover, the breakwaters 300, 302 are preferably constructed of material (e.g., reinforced concrete) that resists deformation in response to tsunami, earthquake, collision, explosion, or other forces sufficiently to keep the MPS 100 from mobilizing during such events in a way that would threaten operation of the reactors within the nuclear envelope 110.

Lateral bumpers (e.g., bumper 308) constrain the peak amplitude of forces communicated between the MPS 100 and the breakwaters 300, 302, in the event that either off the breakwaters 300, 302, the MPS 100, or both are mobilized, thus preventing or reducing damage to the MPS 100 caused by such forces. In various embodiments, mobilization of and damage to the MPS 100 are also minimized by additional motion constraint devices (not depicted), such as a cables, chains, bumpers on endwalls, or the like. In an example, it will be clear that bumpers, cables, and endwalls (not depicted) may constrain the MP 100 from excessive longitudinal displacement.

The water within the slip, the structure of the MPS 100, and the breakwaters 300, 302 all contribute to shielding the nuclear envelope 110 from aircraft impacts, vessel impacts, explosions, missiles, and the like, to a degree that satisfies or surpasses regulatory requirements for hardening of nuclear facilities. These structures also tend to act as radiation containment barriers in the event of a major release of radioactive material within the MPS 100.

With continued reference to FIG. 2, FIG. 3A, and FIG. 3B, it is noted that the MPS 100 will include and/or have associated with it one or more stabilizers and/or stabilizing systems. The stabilizers, such as the bumpers 212, 308 are employed to maintain the MPS 100 in a stable condition when installed at the deployment location. Stability of the MPS 100 encompasses maintaining the MPS 100 within certain operational conditions to assure that the nuclear reactor can operate in a safe manner. Stability may be complimented and/or enhanced by the ballast system in and/or associated with the building structure of the MPS 100. Stability encompasses, but is not limited to, limiting the effects on the MPS 100 by the following four variables: (1) seismic events, (2) lateral shocks, (3) list angle, and (4) tilt acceleration. Seismic events include, but are not limited to, earthquakes and other terrestrial events. It is contemplated that the stabilizers and/or stabilizing systems provided for the MPS 100 will cushion the impact of seismic events up to 1 g (the force of gravity) acting on the MPS 100. Lateral shocks include, but are not limited to, impacts from objects exterior to the MPS 100. For terrestrial nuclear power plants, the containment dome is intended to withstand the impact of a commercial airliner thereon. List angle refers to limits on the tilt of the building structure of the MPS 100. It is contemplated that the building structure will not be permitted to tilt more that about 10° from a vertical position. Tilt acceleration refers to the speed of the tilt. Here, the stabilizers are contemplated to maintain the building structure so that it does not tilt more than 10° in 1 second.

With respect to the MPS 100, it is noted that the MPS 100 will satisfy at least the following four parameters: (1) stability, (2) containment, (3) security, and (4) nuclear non-proliferation. The parameters associated with stability are discussed above. The building structure of the MPS 100 also is contemplated to be constructed to be sufficiently robust so that nuclear materials remain contained within the building structure. As for security, the building structure is contemplated to be designed to provide sufficient safeguards to prevent the power plant from becoming damaged accidentally or intentionally, such as by sabotage. Concerning nuclear non-proliferation, the building structure also is contemplated to incorporate features that prevent access to nuclear materials. This includes, but is not limited to, safeguards to prevent individuals from stealing fissile material. This also encompasses features that permit inspection by appropriate nuclear regulatory inspectors, as appropriate.

Returning to FIGS. 3A and 3B, in various other embodiments, the MPS 100 is not ballasted down until it contacts the bottom of the slip or structures mounted thereon, but floats freely within the slip. In this case, the water between the bottom of the MPS 100 and the slip floor provides a degree of seismic isolation that is proportional to the depth of the water.

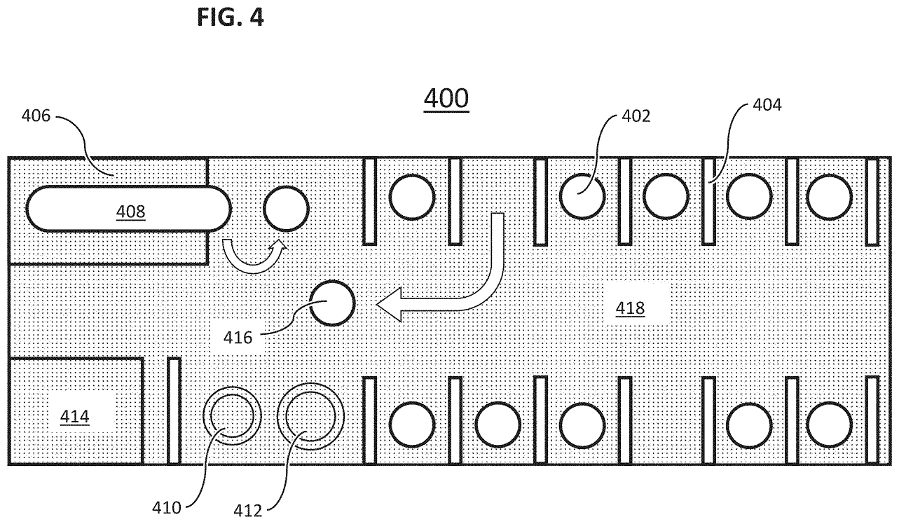

FIG. 4 depicts in top-down schematic view the layout of the interior of a nuclear envelope 400 that can be installed within an MPS 100 according to an illustrative embodiment of the invention. The illustrative nuclear envelope 400 resembles a reactor building design for the containment of NuScale SMRs known to the prior art: that is, the regulator-approved layout of a terrestrial nuclear island of this type can, in this example, be incorporated wholesale into an MPS. Design and construction of the MPS thus benefits from regulatory approvals previously granted. Other envelope designs for NuScale SMRs and reactors of other types, both those that have received prior regulatory approval and those that have not, are also contemplated and within the scope of the invention. The envelope 400 comprises 12 SMRs, e.g., SMR 402, each having the approximate form of an oblong capsule with a circular cross-section. In its operational position, each SMR 402 stands between two retaining walls (e.g., wall 404). Horizontally oriented SMRs (e.g., SMR 408) are delivered into the envelope 400 to a fuel handling area 406, which comprises an upending machine that can rotate the reactor individual reactor components to a vertical position. The upending machine can also rotate vertically oriented reactor components to a horizontal position preparatory to their removal from the envelope 400. The envelope 400 also comprises handling fixtures or stations 410, 412 where an SMR can be positioned for refueling. A fuel pool 414 accommodates fresh and spent fuel that to be exchanged with open SMRs accommodated by the stations 410, 412. One or more heavy-duty overhead bridge cranes (not depicted) run the length and width of the envelope 400, enabling the transport of SMRs, fuel units, and other objects within the envelope. A curved arrow indicates transport of an SMR 416 from its operational bay to the handling area at left. All motions of SMRs within the envelope 400 are reversible: e.g., the handling area 406 serves equally for delivering SMRs and fuel into the envelope 400 and removing them therefrom.

When installed in its operational bay, as discussed above, each SMR 402 is connected to a steam loop that conveys thermal energy from the SMR 402 to turbine-generators outside the nuclear envelope 400, whether these turbine-generators are aboard the MPS 100 containing the nuclear envelope 400 or located outside the MPS 100. Steam, electrical, and data connections as well as numerous other components are omitted from FIG. 4 for clarity.

In a typical operational state, the illustrative nuclear envelope 400 is filled approximately to the height of the SMRs 402, which stand within a water pool 418. The pool 418 serves the dual purpose of radiation shielding and providing a heat-sink for emergency cooling. The volume of water in the pool 418 is at least adequate to remove by evaporation all heat generated by the SMRs 402 in the event that such evaporation becomes the primary or sole means of safely dissipating heat generated by nuclear fission reactions within the SMRs 402, that is, in any accident involving a loss of active cooling. The volume of the pool 418 is sized so that by the time it is substantially evaporated, fission reactions in the SMRs 402 will have subsided to the point where air cooling alone will maintain the SMRs 402 in a safe, intact condition.

Preferably, the nuclear envelope 400 is built into an MPS, e.g., the illustrative MPS 100 of FIG. 1, during shipyard construction, but during transport of the MPS 100 to a site of coastal deployment the envelope 400 is empty both of water and SMRs 402. During MPS 100 transport, this empty configuration rules out nuclear incidents and obviates the problem of slosh in the large pool 418. SMRs 402 are preferably installed and fueled within the envelope 400 once the MPS 100 is ballasted down and otherwise secured in its operational position. In various embodiments, anti-slosh systems (not depicted) are added to the interior of the nuclear envelope to mitigate slosh caused by any forced motion of the operational MPS 100, as for example by an earthquake.

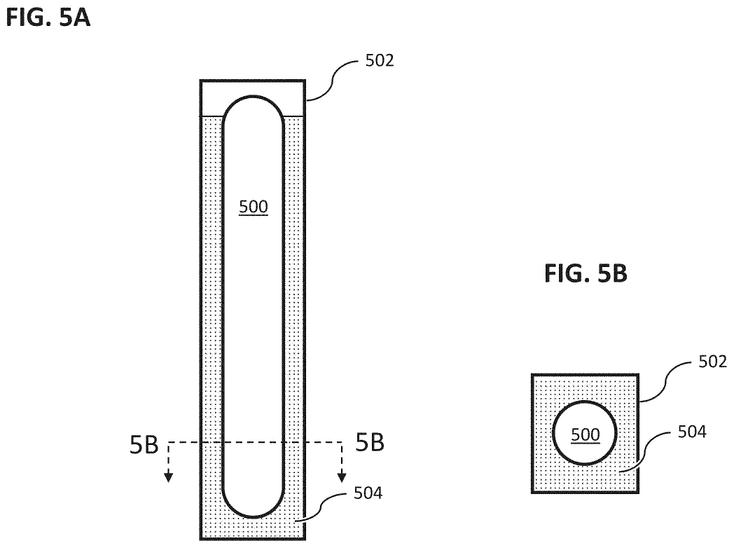

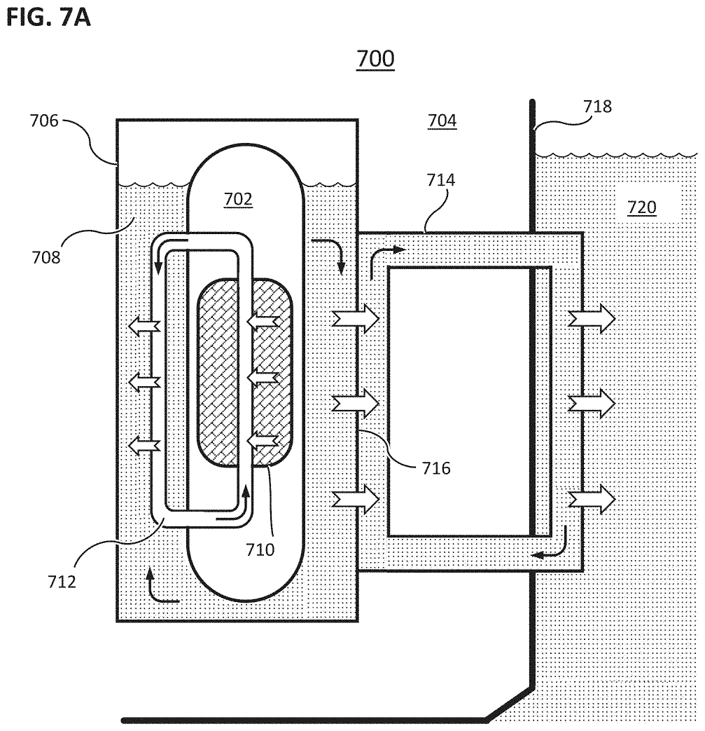

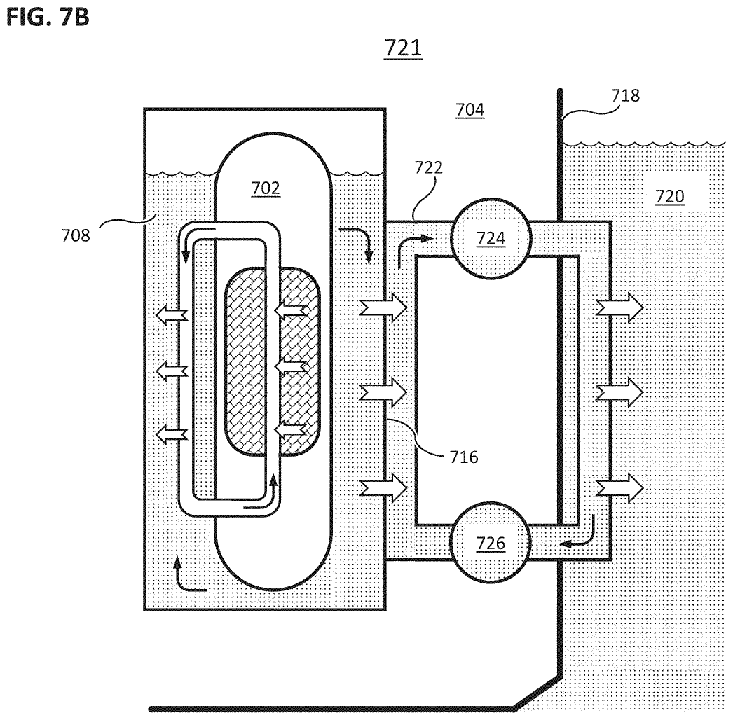

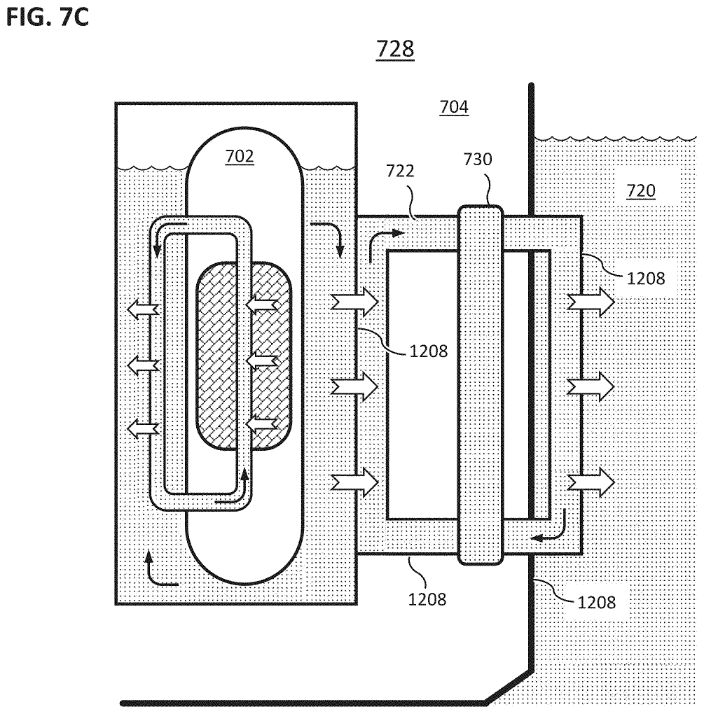

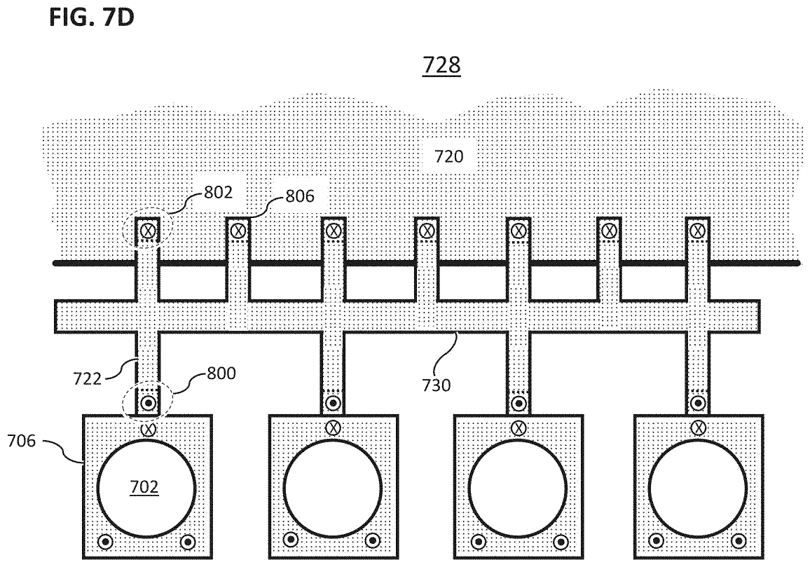

FIG. 5A and FIG. 5B schematically depict an SMR 500 enclosed in a dedicated coolant container 502 filled partly or wholly with coolant 504. The SMR 500 has an oblong, upright shape typical of such reactors. The volume of coolant in the container 502 is not, in general, large enough to safely dissipate by evaporation all excess heat from the SMR within the container 502 in the event that active cooling of the SMR 500 (e.g., via the turbine-generator steam loop) ceases. Therefore, a mechanism for removal of excess heat from SMRs within dedicated coolant containers during loss of active cooling, according to some embodiments of the invention, will be described hereinbelow with reference to FIG. 7, FIG. 8, and FIG. 9. The coolant 504 and other bodies of coolant referred to herein are preferably water but there is no restriction to water; herein, any references to coolant as “water” are to be understood as inclusive of all viable coolant fluids. The rectangular cross-section of the coolant container 502 is illustrative only: there is no restriction on the overall geometry of dedicated coolant containers.

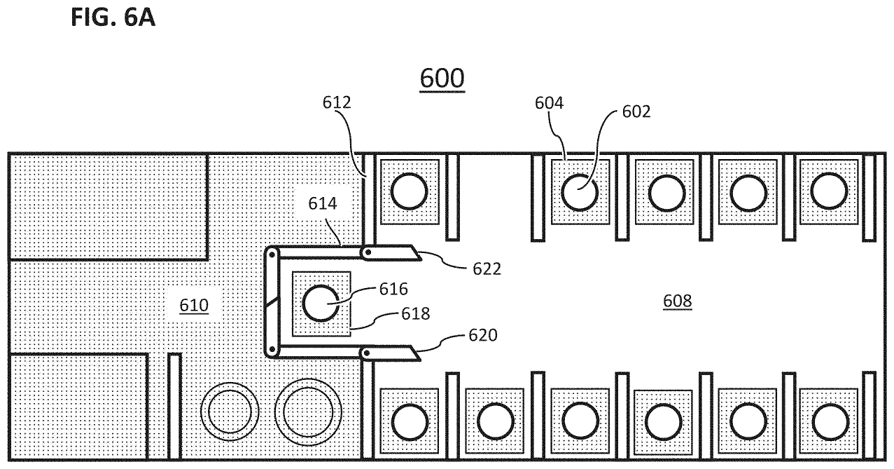

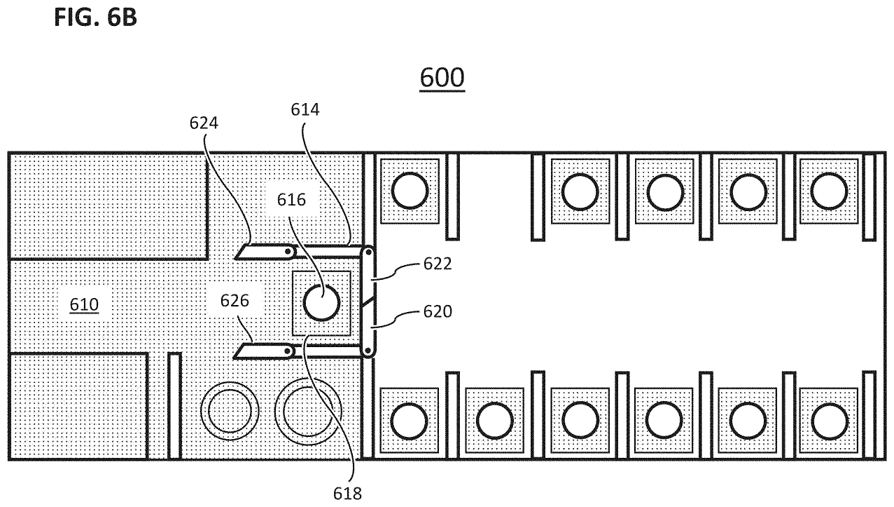

FIG. 6A schematically depicts in view portions of the layout of the interior of a nuclear envelope 600 that can be installed within an MPS 100 according to an illustrative embodiment of the invention. The nuclear envelope 600 resembles envelope 400 of FIG. 4 in many respects, but is modified so that each SMR (e.g., SMR 602) is enclosed in a dedicated, water-filled coolant container (e.g., coolant container 604) similar to container 502 of FIG. 5. Because each SMR 602 is cooled by passive convection within its dedicated coolant container 604, and removal of heat from the coolant container 604 by means that shall be made clear with reference to later Figures, the size of the coolant pool in the nuclear envelope 600 can be greatly reduced. This (1) advantageously reduces the amount of radioactively contaminated coolant that must be processed during routine operation and/or decommissioning of the nuclear envelope 600, (2) essentially eliminates slosh in the reactor chamber 608 in case of a seismic event or other forced motion of the operational MPS 100 within which the envelope 600 resides, and (3) keeps each SMR 602 in contact with coolant in the event of a breach of the nuclear envelope 600 that allows water to drain from the reactor chamber 608. Coolant containers holding SMRs 602 are, in various embodiments, moved about within the nuclear envelope 600 either by an overhead bridge crane (not depicted) or by floor-level heavy transporters (also not depicted), such as air cushion mobile platforms, that are known to the art of the power industry for the shifting of transformers and other heavy items.

A handling pool 610 is maintained in the SMR-handling and -refueling portion of the nuclear envelope 600 and is divided from the reactor chamber 608 by a barrier 612 that comprises a lock 614. In FIG. 6A, the lock 614 is depicted in a first state of operation in which an SMR 616, housed in its dedicated coolant container 618, is moved into the chamber of the lock 614 through a first pair of gates 620, 622, the chamber of the lock being empty of coolant.

FIG. 6B depicts the nuclear envelope 600 of FIG. 6A in a second state of operation of the lock 614 wherein the first pair of gates 620, 622 has been closed, the chamber of the lock 614 has been filled with coolant to the level of the handling pool 610, and a second pair of gates 624, 626 has been opened. In this second state of operation, SMR 616 in its dedicated coolant container 618 can be moved into the handling pool 610 for refueling, defueling, removal from the nuclear envelope, and other operations. It will be clear that passage of the SMR 616 in its dedicated coolant container 618 through the lock 614, like all other object movements within the nuclear envelope, is reversible.

FIG. 7A schematically depicts in vertical cross-section portions of a passive heat-exchange mechanism 700 (passive cooling system 700) for providing passive cooling to an SMR 702 in an MPS 704 according to an illustrative embodiment of the invention. The SMR 702 is contained with a dedicated coolant container 706 similar to container 500 of FIG. 5. The container 706 is filled or almost filled with coolant 708. The SMR 702 comprises a nuclear reactor core 710. A primary passive coolant loop 712 passes through the core 710, out of the SMR 702, through the coolant 708, and back into the SMR 702. Various components, such as the walls of the nuclear envelope, a steam loop to transfer thermal energy from the SMR 702 to a turbine-generator set, and others, are omitted from FIG. 700 for clarity.

In the state of operation depicted in FIG. 7A, the SMR is being cooled only by passive, convective coolant flows. Heat transfer in FIG. 7A is indicated by fork-tailed open arrows and coolant movement is indicated by solid black arrows. Thus, heat is transferred from the core 710 to the primary coolant loop 712 and from thence to the coolant 708 within the container 706. As indicated by black arrows, coolant tends to rise in volumes that are being heated and to descend in volumes that are being cooled.

The heat-exchange mechanism 700 also comprises a secondary cooling loop 714. A portion of the secondary loop 714 is in contact with a thermally conductive wall 716 of the coolant container 706, and another portion passes through the hull 718 of the MPS 704, makes contact with a large body of water 720 (e.g., seawater in a slip wherein the MPS 704 is berthed), and returns. Heat is thus transferred from the coolant 708 to the secondary loop 714 and from thence to the water body 720. Preferably the secondary loop 714 is of sufficient flow capacity, and the thermal interface between the secondary loop 714 and the container 706 is sufficiently conductive, that coolant 708 within the container 706 is prevented indefinitely from being evaporated by heat from the core 710 even there is no active cooling of the SMR 702 and the water body 720 is at a relatively warm (e.g., tropical surface waters) temperature.

The mechanism 700 of FIG. 7A thus comprises a dedicated, discrete secondary coolant loop 714 for the SMR 702 housed by an MPS 704. Other SMRs 702 (not depicted in FIG. 7A) that are housed by the MPS 704 are likewise equipped with dedicated, discrete secondary coolant loops similar to loop 714. Of note, blockage of any part of a secondary coolant loop (e.g., loop 714), e.g., blockage or crimping of the portion of loop exchanging heat with the water body 720, will terminate convective heat removal of heat from the SMR 702. Illustrative embodiments discussed with reference to FIG. 7B and FIG. 7C avoid this problem.

FIG. 7B schematically depicts in vertical cross-section portions of a heat-exchange mechanism 721 for providing passive cooling to SMRs (e.g., SMR 702) in an MPS 704 according to an illustrative embodiment of the invention. The mechanism 721 differs from mechanism 700 of FIG. 7A in that the upper transverse portion of the secondary coolant loop 722 communicates with an upper coolant-filled manifold 724, shown in transverse cross section in FIG. 7B. The upper manifold 724 is a pipe or chamber that runs perpendicular to the drawing plane of FIG. 7B. The interior of the coolant loop 722 is in fluid communication with the interior of the manifold 724 and exchanges coolant freely therewith. Similarly, the lower transverse portion of the secondary coolant loop 722 is in fluid communication with a lower manifold 726 that runs parallel to the upper manifold 724. Moreover, other SMRs 702 housed on the depicted side of the MPS 704, arranged in a row perpendicular to the plane of the drawing (e.g., as shown in FIG. 6A), are equipped similarly with their own secondary cooling loops that communicate with the upper manifold 724 and lower manifold 726: that is, there is a port and a starboard set of SMRs, loops, and manifolds. Thus, all secondary coolant loops on this side of the MPS 704 are in fluid communication with the manifolds 724, 726 and consequently with each other.

Compared to mechanism 700 of FIG. 7A, mechanism 720 of FIG. 7B has the advantage that in the event that portions of one or more SMR secondary coolant loops that deliver heat to the water body 720 are blocked or crimped, e.g., by collision or explosion, coolant can continue to circulate through the manifolds 724, 726 and all secondary coolant loops in communication therewith, continuing to transfer heat from SMRs 702 to the water body 720. All coolant loops and manifolds are preferably sized to transfer sufficient heat by passive convective circulation, even in the event of blockage of some fraction (e.g., half) of secondary loops, to keep the SMRs 702 in a safe temperature range.

FIG. 7C schematically depicts in vertical cross-section portions of a heat-exchange mechanism 728 for providing passive cooling to SMRs (e.g., SMR 702) in an MPS 704 according to an illustrative embodiment of the invention. The mechanism 728 differs from mechanism 720 of FIG. 7B in that the upper and lower transverse portions of the secondary coolant loop 722 communicate with a single coolant-filled manifold 730, which is shown in transverse cross section in FIG. 7C. The manifold 730 is a chamber, tank, or coolant-filled wall that runs perpendicular to the drawing plane of FIG. 7C. Other SMRs 702 housed on the depicted side of the MPS 704, arranged in a row perpendicular to the plane of the drawing, are equipped similarly with their own secondary cooling loops that communicate similarly with the manifold 730. Thus, all secondary coolant loops on the depicted side of the MPS 704 are in fluid communication with the manifold 730 and, through the manifold 730, with each other. SMRs 702 ranged along the opposite side of the MPS 704 are preferably served by a similar heat-exchange mechanism: that is, there is a port and a starboard set of SMRs, loops, and manifold. In the event that the portion of any one or more secondary cooling loops that exchanges heat with the water body 720 is blocked or crimped, coolant can continue to circulate through the manifold 730 and all secondary coolant loops connected thereto. This is advantageous compared to the manifold arrangement of FIG. 7B in that, while the horizontal manifolds of FIG. 7B could themselves conceivably be blocked or crimped, isolating the secondary coolant loops of one or more SMRs 702, which might in their turn be blocked or crimped, the manifold 730 is essentially unblockable because of its large size. Moreover, the manifold 730 acts as an additional radiation and impact shield housed within the MPS 704.

FIG. 7D schematically depicts a top-down view of portions of the heat-exchange mechanism 728 of FIG. 7C. Each SMR (e.g., SMR 702) is housed within a dedicated coolant container (e.g., container 706). Each container is in thermal conductive communication with a secondary coolant loop, e.g., container 706 is in thermal conductive communication with loop 722. In FIG. 7D, for simplicity, a single horizontal portion of each secondary loop is depicted, and the two vertical portions (herein termed “risers”) of each secondary loop are depicted as squares bounded on one side by a broken line, with the preferred direction of convective fluid flow within the riser depicted as a cross-in-circle symbol where flow is up into the drawing plane and as a dot-in-circle symbol where flow is down into the drawing plane. For example, riser 800 of loop 722 is in thermal conductive communication with container 706, and coolant within the riser 800 will tend up out of the drawing plane and thus indicated with dot-in-circle symbol. Likewise, riser 802 of loop 722 is in thermal conductive communication with the water body 720 and coolant within the riser 802 will tend to flow down into the drawing plane. Simultaneously, coolant will tend to circulate convectively within the container 706: direction-of-flow symbols indicate that coolant sinks in the container 706 where heat is being delivered to riser 800 and rises in at least some other portions of the container 706. Convective flows within the manifold 730 are either permitted to occur without interference, or, if necessary to assure adequate convective heat shedding to the water body 720 under all plausible accident conditions, will be impeded by baffles internal to the manifold 730.

The manifold 730 is in fluid communication not only with all the secondary cooling loops of FIG. 7D, but with a number of additional exterior loops (e.g., half-loop 806) that also deliver heat by convective circulation to the water body 720. The fluid capacity and total number of exterior loops is preferably great enough that even if a significant fraction of exterior loops are blocked or crimped, convective flow through exterior loops will continue to remove sufficient heat from the SMRs 702 to keep the later in a safe condition. In FIG. 7D, the number of exterior loops (i.e., 7) for the number of SMRs 702 (i.e., 4) is illustrative only.

As should be apparent from the forgoing, the present invention encompasses several aspects. While not intending to limit the present invention, the following discussion highlights several aspects that are intended to fall within the scope of the present invention.

In one contemplated embodiment of the present invention, the present invention is contemplated to encompass a structural facility/building and/or vessel that satisfies nuclear qualified and marine structural codes and standards.

The building structure is contemplated to comprise distinct modules that are designed to be transported, in the most efficient fashion (road rail, by water), to a specific geographical and/or marine site/location (e.g., the deployment location) for rapid assembly.

Whether used alone or in combination with others, each MPS 100 (including other embodiments described herein and their equivalents) is contemplated to encompass movable/transportable and fixed structures, systems and components that provide safety, stability, security and a nuclear non-proliferation function, as discussed above. As noted above, safety includes, but is not limited to, components, systems, and equipment intended to isolate the power plant from the effects that can be introduced by the site it is deployed on, such as ship-collisions, effects of tsunamis, and seismic and/or other ocean events. Stability includes stabilizing systems to maintain the MPS 100 in a proper orientation for operation of the power generation systems installed in the building structure. Security includes, but is not limited to, measures employed to deter potential theft of equipment and mitigate the effects of malevolent acts. Nuclear non-proliferation features include, but are not limited to, those that are used to deter potential diversion of sensitive nuclear materials from the facility.

As noted above, safety features that might be employed in connection with the present invention encompass stabilizers, such as dampening devices and shock absorbing structural members, that may be combined with civil structural elements and mooring/anchoring technologies (within the structure as well as outside the structure/exterior). Safety also encompasses features permitting the MPS 100 to be anchored to a prepared seabed, with or without supplemental dampening devices. And, as discussed hereinabove, safety features also include a breakwater and/or berm structures surrounding the MPS 100.

The MPS 100 is anticipated to meet structural robustness requirements under applicable laws and/or regulations worldwide. This includes the use of a double hull outfitted with Y-shape stringers to provide optimal collision and impact resistance, as discussed above. In addition, as a movable structure, the MPS 100 is designed to meet relevant transport regulations and is transported either via dry tow or wet tow.

It is contemplated that the MPS 100 may be either outfitted at the shipyard of origin with necessary marine and power plant systems, including nuclear and non-nuclear power plant components. It is also contemplated that the MPS 100 may be moved to a single location (or sequentially to several different locations) for marine and power plant outfitting, including outfitting with nuclear and non-nuclear power plant components. Still further, the MPS 100 may be moved to deployment site for marine and power plant outfitting, including outfitting with nuclear and non-nuclear power plant components.

The MPS 100 may or may not include one or more reactor components during transport. Still further, the MPS 100 may or may not comprise a single or multiple fueled reactors onboard during transport. In addition, the MPS 100 may or may not have nuclear fuel on-board during transport. If nuclear fuel is onboard, the nuclear fuel may be stored in qualified fuel transport containments or packages.

Upon delivery of the MPS 100 to a suitable facility, such as a shore-side location, the MPS 100 is contemplated to include, in one embodiment, a fully standalone power plant unit, including all components of a nuclear power plant. Alternatively, the MPS 100 may be delivered in a condition where the MPS 100 includes some, but not all, of the components of a nuclear power plant. In particular, selected components of the nuclear power plant may be located on the shore-side facilities.

In another contemplated embodiment, the MPS 100 is contemplated to be positioned within a prepared harbor or dock. If so, the MPS 100 may float above a prepared seabed (e.g., a foundation below the surface of the body of water). In another configuration, as discussed above, the MPS 100 may be ballasted partially or fully onto the prepared seabed.

It is contemplated that the depth of the body of water where the MPS 100 is positioned will be of a sufficient depth so that the MPS 100 may be ballasted to a maximum draft to protect the structure from aircraft impact. In this configuration, the MPS 100 is contemplated to be moored or anchored, either partially or fully with a harbor and/or dock/shore facility. The harbor and/or dock/shore facility may encompass part or all of the MPS 100.

Where the MPS 100 is located in a harbor and/or dock/shore facility, it is contemplated that the harbor and/or dock/shore facility will be outfitted with stabilizers including lateral shock absorbers, such as bumpers, shock absorbing fenders, dampeners, and seismic isolation systems, among others, as noted.

After the MPS 100 is secured in the harbor and/or dock/shore facility, it is contemplated that the MPS 100 will be connected to the dock/shore infrastructure that includes, but is not limited to, a shore side power transmission and grid infrastructure. If the MPS 100 includes merely the fission power reactors and power conversion systems (such as turbine generators) are located on the dock/shore infrastructure, then the MPS 100 is contemplated to be connected via adequate piping/connector systems to the dock/shore infrastructure.

In one contemplated embodiment, the control room is not located in the MPS 100. In this embodiment, the control room is contemplated to be included as a part of the dock/shore infrastructure. Still further, the control room may be included on the MPS 100.

It is also contemplated that the MPS 100 may be transported to the deployment location with pre-fueled nuclear reactors installed therein. Alternatively, the MPS 100 may be delivered to the deployment location without any nuclear reactors on board. Here, the nuclear reactors are contemplated to be installed after the MPS 100 is installed at the deployment location. Still further, the MPS 100 may be transported to the deployment location with the nuclear reactors on board, but with no nuclear fuel. Here, it is contemplated that the nuclear fuel will be loaded after the MPS 100 is installed at the deployment location.

In an embodiment where the MPS 100 incorporates an internal coolant pool, the MPS 100 may be delivered to the deployment location with or without the coolant on board. If the MPS 100 is delivered with the coolant on board, the MPS 100 may be provided with suitable anti-slosh systems.

Once installed, it is contemplated that the MPS 100 will be protected, at the shore side, via suitable security systems including, but not limited to, fencing, surveillance systems, physical security structures, a physical breakwater, berm structures, and the like.

If fueling and/or refueling is contemplated to occur at the deployment location, it is contemplated that the MPS 100 may include a spent fuel pool and/or a nuclear fuel dry storage cask loading facility. Conventional dry casks as well as replaceable, factory fueled core units may or may not be located on the dock/shore infrastructure.

As should be apparent from the foregoing, it is contemplated that the MPS 100 will be outfitted with redundant cooling systems. For example, the reactor core is contemplated to be immersed in a primary coolant housed in a primary coolant system. The reactor core may be housed in a containment vessel, and the containment vessel may be immersed in a containment cooling pool. The containment vessel is contemplated to prohibit a release of the primary coolant outside of the containment vessel. The containment cooling pool may be constructed, in another embodiment, so that one or more inlets, which are submerged in the containment cooling pool, are configured to draw secondary coolant from the containment cooling pool during an emergency operation, such as when there is a loss of secondary coolant flow.

As discussed above, the MPS 100 is contemplated to include at least one heat exchanger that is in contact with the primary coolant. The heat exchanger is configured to remove heat generated by the reactor core. The heat is removed by circulating secondary coolant from the containment cooling pool within the MPS 100 through the heat exchanger via natural circulation.

In another contemplated embodiment, a dedicated coolant container may enclose the containment vessel. Here, the dedicated coolant container encloses the containment. The containment prohibits release of the primary coolant outside of the containment vessel.

In yet another contemplated embodiment, a dedicated coolant container is contemplated to enclose the containment vessel, which is immersed in a coolant. Here, a heat exchanger is configured to remove heat generated by the reactor core and transferred into the primary coolant surrounding the reactor containment within the dedicated coolant container. The heat is removed by circulating the secondary coolant from the containment cooling pool within the structure through the heat exchanger via natural circulation.

The MPS 100 is contemplated to be installed within a harbor prepared to receive the MPS 100. In this configuration, the MPS 100 is contemplated to abut lateral fenders and dampeners, limiting structural movement, e.g., pitch and roll, of the MPS 100 during normal operation.

The MPS 100 is contemplated to be configured so that the building structure may be decontaminated and decommissioned so that the MPS 100 may be relocated from the deployment location to a decommissioning facility, for example.

The foregoing has been a detailed description of illustrative embodiments of the invention. Various modifications and additions can be made without departing from the spirit and scope of this invention. Each of the various embodiments described above may be combined with other embodiments in order to provide multiple features. Any of the abovementioned embodiments can be deployed on a floating or grounded nuclear plant platform located in a natural body of water or along a natural or man-made coastline. Furthermore, while the foregoing describes a number of separate embodiments of the apparatus and method of the present invention, what has been described herein is merely illustrative of the application of the principles of the present invention. Accordingly, this description is meant to be taken only by way of example, and not to limit the scope of this invention.

What is claimed is:

1. A marine power structure, comprising:
a building structure adapted to float on a body of water having a water surface, wherein the building structure is transportable to a deployment location;
a nuclear enclosure disposed within in the building structure;
a nuclear reactor disposed within the nuclear enclosure, wherein the nuclear reactor generates heat;
a primary coolant system connected to the nuclear reactor, wherein the heat is transferred to a primary coolant within the primary cooling system and wherein the primary coolant, after being heated, generates a heated fluid; and
at least one stabilizer adapted to engage the building structure, wherein the at least one stabilizer assists to maintain the stability of the building structure at the deployment location.

2. The marine power structure of claim 1, further comprising:
a ballast system, wherein the ballast system is adapted to alter a buoyancy of the building structure, permitting at least a portion of the nuclear enclosure to be lowered below the water surface.

3. The marine power structure of claim 1, wherein the building structure excludes a propulsion system.

4. The marine power structure of claim 1, wherein the nuclear reactor comprises a small modular reactor having a power output of between about 1 megawatts (MWe) to about 100 megawatts (MWe).

5. The marine power structure of claim 1, wherein the building structure comprises an outer hull and an inner hull, wherein the inner hull is disposed within the outer hull, wherein a space is defined between the inner hull and the outer hull, and wherein the space contains at least one of Y-shape stringers, water, liquid, granular material, concrete, and radiation shielding.

6. The marine power structure of claim 1, wherein the nuclear reactor comprises a plurality of nuclear reactors.

7. The marine power structure of claim 1, further comprising:
a fuel handling area within the nuclear enclosure, permitting transfer of nuclear fuel to and from the nuclear reactor.

8. The marine power structure of claim 1, further comprising:
a passive cooling system connected between the nuclear reactor and the body of water to passively conduct heat from the nuclear reactor to the body of water.

9. The marine power structure of claim 8, wherein the nuclear reactor is disposed within a container and the passive cooling system comprises a secondary cooling loop in thermal contact with the container.

10. The marine power structure of claim 9, wherein the secondary cooling loop comprises a manifold and a plurality of vertically-oriented loops connected to the manifold and wherein the plurality of vertically-oriented loops are disposed exteriorly to the building structure, within the body of water.

11. A coastal nuclear power station, comprising:
a harbor comprising a landmass abutting a body of water having a water surface;
a slip extending into the landmass, wherein the slip comprises at least one breakwater defining a transition from the landmass to the body of water;
a marine power structure disposed within the slip, comprising
a building structure adapted to float on a body of water having a water surface, wherein the building structure is transportable to a deployment location,
a nuclear enclosure disposed within in the building structure,
a nuclear reactor disposed within the nuclear enclosure, wherein the nuclear reactor generates heat,
a primary coolant system connected to the nuclear reactor, wherein the heat is transferred to a primary coolant within the primary cooling system and wherein the primary coolant, after being heated, generates a heated fluid, and
at least one stabilizer adapted to engage the building structure, wherein the at least one stabilizer assists to maintain the stability of the building structure at the deployment location; and
a foundation disposed within the slip, beneath the water surface, at the deployment location, wherein the foundation is adapted to receive the building structure.

12. The coastal nuclear power station of claim 11, further comprising:
a ballast system, wherein the ballast system enables the building structure to float on the water surface and also to sink into the body of water and rest atop the foundation.

13. The coastal nuclear power station of claim 13, wherein, when the building structure rests atop the foundation, at least a portion of the nuclear enclosure is below the water surface.

14. The coastal nuclear power station of claim 13, further comprising:
a plurality of seismic isolators disposed on the foundation, between the foundation and the building structure.

15. A method for managing a marine power structure, comprising:
constructing a slip into a landmass, wherein the slip comprises at least one breakwater defining a transition from the landmass to a body of water with a water surface;
laying a foundation in the slip beneath the water surface;
delivering a marine power structure to the slip, wherein the marine power structure comprises
a building structure adapted to float on the water surface,
a nuclear enclosure disposed within in the building structure,
a nuclear reactor disposed within the nuclear enclosure, wherein the nuclear reactor generates heat, and
a primary coolant system connected to the nuclear reactor, wherein the heat is transferred to a primary coolant within the primary cooling system and wherein the primary coolant, after being heated, generates a heated fluid; and
reducing the buoyancy of the building structure until the building structure rests on the foundation and engages at least one stabilizer adapted to engage the building structure to maintain the stability of the building structure in the slip.
